(19) United States
(12) Patent Application Publication
(10) Pub. No.: US 2010/0262919 A1
(43) Pub. Date: Oct. 14, 2010

(54) Method of remotely providing a computer service

(76) Inventor: Peter Spezza, Fort Myers, FL (US)

Correspondence Address: Computer Centers USA Inc., 14261 S. Tamiami Trail Unit #4, Fort Myers, FL, 33912, US

(21) Appl. No.: 12/385,470

(22) Filed: Apr. 9, 2009

(51) Int. Cl. G06F 3/01

(52) U.S. Cl. 715/740

(57) ABSTRACT

The inventive method pertains to a method of remotely servicing a computer or more precisely it is directed to repairing a computer that has gone astray in its proper function. The method is a service by subscription that involves a USB stick that is plugged into a USB port on the computer. The computer screen will give different prompts with regard to how to proceed. A professional technician will come on line in real time and analyze the problems of the computer and will be able to make moves by remote control and in real time. The remote analysis works from anywhere with an internet connection. One of the first things the technician will check is the settings of the computer. This allows the technician to become familiar with the operating system, programs and configurations. The technician will install anti-virus, malware, spy ware, adware internet filter utilities and proceed to scan the computer for security breeches and bring the computer back to its normalcy.

### BACKGROUND OF THE INVENTION

Computer services are known. The services are needed if a computer goes astray, that is, if certain functions cannot be performed without the intervention of a professional technicians. Such technicians either come to where the computer is located or a service is performed through the use of a telephone. While use of the telephone is considered to be providing a remote service, it still involves the operator sitting in front of the computer and receiving instructions from the technician who instructs the operator to perform certain key strokes on the computer until the problem is solved.

### BRIEF DESCRIPTION OF THE INVENTION

The concept of this invention eliminates or removes the computer operator as a middle man to some extent in solving the problem that the operator encountered on the computer. Such problems can be a slow computer, viruses embedded in the system, spy ware, pop-ups, printer setup problems, E-Mail problems, security setups, MPS players etc. The inventive concept involves a “Magic Flash Drive”™. The magic flash drive is a conduit in form of a USB stick that is inserted into the USB port whereby, after several advisory steps appearing on the screen, a professional technician comes into play in a remote location, who can analyze the problem and can by way of a remote control and in real time fix or alleviate the problem. The repair service is undertaken by way of a predetermined subscription fee which will give unlimited technical support online in real time.

### BRIEF DESCRIPTION OF THE DRAWING

FIG. 1 is a flow plan of the steps required to solve a problem.

### DETAILED DESCRIPTION OF THE INVENTION

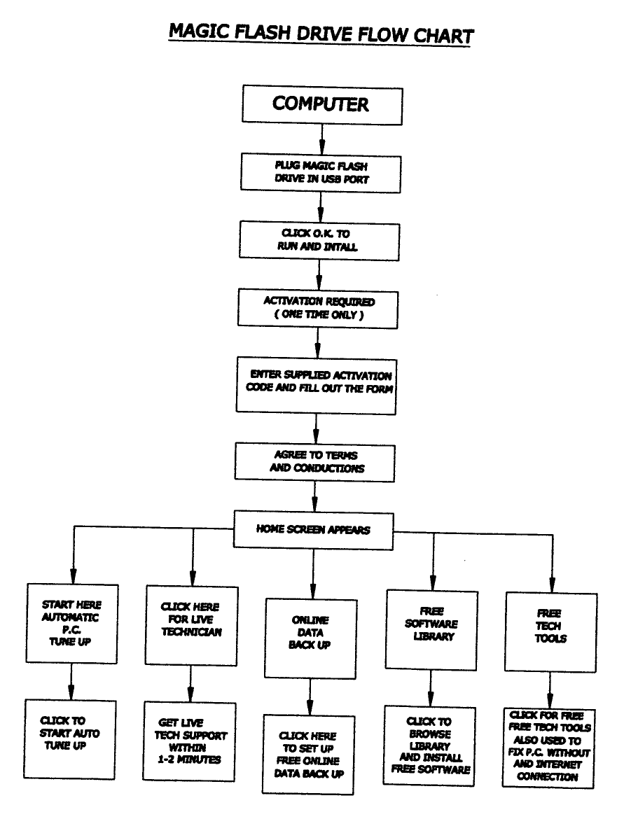

The flow plan depicted in FIG. 1 shows the exact steps that have to be undertaken by a computer operator when any of the above noted problems occur. Once the computer operator has subscribed to the computer repair service a USB stick will be provided. The USB stick is so programmed that when it is inserted into USB port it will display on the computer screen certain steps to be taken by the operator. The various steps to be taken can be a prompt to start here for an automatic P.C. tune-up or a prompt to click here for a live technician. Of course, the technician can solve most any of the problems that are encountered when operating a computer. The technician makes any adjustments or necessary adjustment that come to technician's awareness or knowledge without having to tell the computer operator what to do.

The flow plan in FIG. 1 easily explains the various features that are available to a person sitting in front of a computer. This can involve an online data backup, a free software library, free technical support tools to enable a computer operator to fix the personal computer without the internet. The flow plan is self-explanatory as to various steps to be taken

What I claim is:

1. A method of receiving a remote computer service for problems encountered by a person operating a computer comprising the steps of plugging a programmed USB stick into a USB port of the computer, following thereafter the prompts that appear on the computer screen, said prompts are to click on a prompt for an automatic personal computer tune up, to click on a prompt to summon a live professional technician, said technician can analyze and most any problems encountered and fix the same by remote strokes from the technicians computer without having to involve the operator.

2. The method of claim 1 includes the step of a requirement for activating the service.

3. The method of claim 2, wherein said requirement involves the step of subscribing to said service.
